(19) United States
(12) Patent Application Publication
(10) Pub. No.: US 2015/0135110 A1
(43) Pub. Date: May 14, 2015

(54) UTILIZING OBJECT CLONING TO ENABLE NESTED DRAG AND DROP

(71) Applicant: International Business Machines Corporation, Armonk, NY (US)

(72) Inventors: Erik J. Burckart, Raleigh, NC (US); Michael P. Etgen, Cary, NC (US); Andrew J. Ivory, Wake Forest, NC (US); David M. Stecher, Durham, NC (US)

(73) Assignee: International Business Machines Corporation, Armonk, NY (US)

(21) Appl. No.: 14/076,206

(22) Filed: Nov. 9, 2013

(51) Int. Cl. G06F 3/0486

(52) U.S. Cl. CPC G06F 3/0486
USPC 715/769

(57) ABSTRACT

Embodiments of the present invention provide a method, system and computer program product for nested object drag and drop enablement utilizing object cloning. In an embodiment of the invention, a method of nested object drag and drop enablement utilizing object cloning includes the detection of a drag event in a GUI of an application and the identification of an object in the GUI associated with the drag event. The method also includes the retrieval in memory of one or more clones of other objects in the GUI that are nested in the identified object and the generation of an avatar for the identified object and the one or more clones. Finally, the method includes the movement in a display of the avatar from a source location of the drag event to a target location of a drop event detected in the GUI of the application.

### BACKGROUND OF THE INVENTION

1. Field of the Invention

The present invention relates to cut-copy-paste and more particularly to nested drag and drop management.

2. Description of the Related Art

Personal computing many decades ago enabled a Herculean advancement in productivity mostly in consequence of the ease in which personal computing devices permitted document creation and management. The word processor, the earliest of killer applications permitted the end user not only to craft the text of a document, but also to manipulate the placement of text through “cutting” and “pasting” from one portion of a document to another. In that early computing environments provided a mere character based, uni-tasking user interface, the act of cutting and pasting largely was limited to a single document, although during the twilight of the character based user interface era, terminate and stay resident applications permitted cutting and pasting not only across different documents in a single application, but also across different documents in respectively different applications.

The advent of the graphical user interface (GUI) computing environment accelerated the growth of personal computing and supported the globalization of the ubiquity of the word processor. The clipboard became a focal point of the new environment, allowing for the intra-computer movement not only of textual data, but also other types of data including graphical objects. The general paradigm for cutting and pasting in a graphical user interface persists today more than twenty years subsequent to the widespread distribution of the first graphical user interface based personal computers—namely the dragging and dropping of an object from a source location to a target location.

Enabling an object for dragging and dropping is a matter of defining a coded reaction to the detected event of a drag and also for a drop. So much is relatively straightforward for a simplistic object. However, for an object which is a composition of other objects, enabling the composite object can be more challenging. Even further, for an object which is a nested composition of other objects, matters can become even more complex. In particular, the program code for dragging and dropping must initially determine whether the object selected for dragging is an object nested within the composition, whether the entire nested composition has been selected for dragging and dropping, or whether only a subset of the nested composition has been selected for dragging and dropping. Additionally determining an avatar to present during the dragging and dropping operation can be largely dependent upon the determination of which portion of the nested composition of objects is selected for dragging and dropping.

### BRIEF SUMMARY OF THE INVENTION

Embodiments of the present invention address deficiencies of the art in respect to dragging and dropping nested compositions of objects and provide a novel and non-obvious method, system and computer program product for nested object drag and drop enablement utilizing object cloning. In an embodiment of the invention, a method of nested object drag and drop enablement utilizing object cloning includes the detection of a drag event in a GUI of an application and the identification of an object in the GUI associated with the drag event. The method also includes the retrieval in memory of one or more clones of other objects in the GUI that are nested in the identified object and the generation of an avatar for the identified object and the one or more clones. Finally, the method includes the movement in a display of the avatar from a source location of the drag event to a target location of a drop event detected in the GUI of the application.

In one aspect of the embodiment, the clones are created and stored with the identified object when the identified object is created for use in the GUI. In another aspect of the embodiment, a drop event is detected in the GUI of the application and the target location is determined from the drop event. Finally, the identified object and the other objects in the GUI that are nested in the identified object are moved to the target location in the GUI.

In another embodiment of the invention, a GUI data processing system is provided with a host computer with memory and at least one processor, an operating system executing in the memory of the host computer, an application hosted by the operating system and providing a GUI with different objects displayed thereon and a nested object drag and drop module coupled to the GUI. The module includes program code enabled upon execution in the memory of the host computer to respond to a drag event in the GUI by identifying an object amongst the objects in the GUI associated with the drag event, by retrieving into the memory one or more clones of other objects in the GUI that are nested in the identified object, by generating an avatar for the identified object and the one or more clones, and by moving a display of the avatar from a source location of the drag event to a target location of a drop event detected in the GUI of the application.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for nested object drag and drop enablement utilizing object cloning;

FIG. 2 is a schematic illustration of a GUI data processing system configured for nested object drag and drop enablement utilizing object cloning; and,

FIG. 3 is a flow chart illustrating a process for nested object drag and drop enablement utilizing object cloning.

### DETAILED DESCRIPTION OF THE INVENTION

Embodiments of the invention provide for nested object drag and drop enablement utilizing object cloning. In accordance with an embodiment of the invention, a drag event can be detected in at a source location in a GUI for a selected object in a nested composition of objects, each object in the nested composition being individually stored in memory of a computer. Thereafter, in response to the drag event, clones for respective ones of the objects that are nested below the selected object can be retrieved into memory and an avatar can be generated for the selected object and its clones. Subsequently, during dragging and prior to dropping, the avatar can be visually displayed in the GUI and moved from the source location to a target location in the GUI. In response to a dropping at the target location, the selected object and those of the objects in the nested composition that correspond to the clones can be placed at the target location.

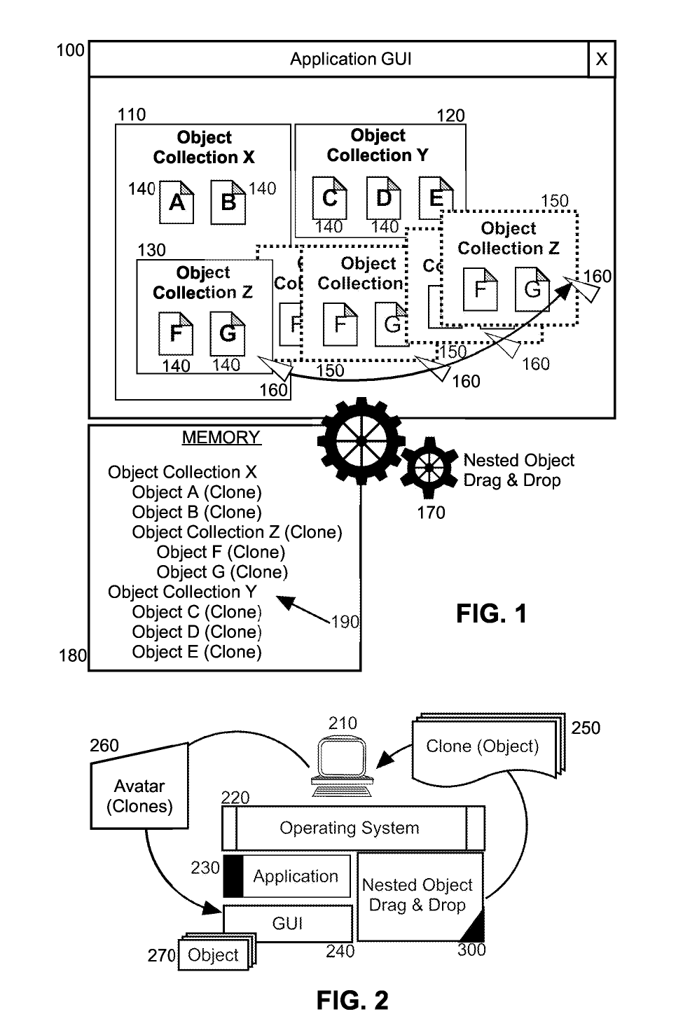

In further illustration, FIG. 1 pictorially shows a process for nested object drag and drop enablement utilizing object cloning. As shown in FIG. 1, an application GUI 100 can be provided for an application and can include different objects 110, 120. The objects 110, 120 can include an association with other contained objects 140 so as to provide for a nesting of the objects 140. Even further, an object 110 that contains nested objects 140 can be nested within object 110 in the GUI 100. Additionally degrees of nesting and numbers of nested objects provided in the GUI 100, though only three objects 110, 120, 130 containing nested objects 140 are shown herein for the purpose of illustrative simplicity.

Nested drag and drop logic 170 can be provided for the GUI 100. The nested drag and drop logic 170 can store in memory 180 in connection with each of the objects 110, 120, clones 190 (or exact data replicas) of the nested objects 140 contained thereby. As such, the clones 190 can include a clone (or exactly data replica) of the object 130 in connection with object 110 along with a clone of the nested objects 140 of the object 130. Utilizing the clones 190, the nested drag and drop logic 170 can respond to a drag event by identifying the object 130 that has been selected in connection with a pointer 160, and by generating an avatar 150 based upon the selected object 130 and the clones of the objects 140 nested therein. Similarly, utilizing the clones 190, the nested drag and drop logic 170 can respond to a drop event by placing the selected object 130 and the objects 140 nested therein at a location in the GUI 100 proximate to a position of the pointer 160 noted within the drop event.

The process described in connection with FIG. 1 can be implemented within a GUI data processing system. In yet further illustration, FIG. 2 schematically shows a GUI data processing system configured for nested object drag and drop enablement utilizing object cloning. The system can include a host computer 210 with memory and at least one processor supporting the execution of an operating system 220. The operating system 220 in turn can host the operation of an application 230 providing a GUI 240 through which an end user interacts with the program logic of the application 230. The GUI 240 can be programmatically linked to a nested drag and drop module 300.

The nested drag and drop module 300 can include program code that when executed in the memory of the computer 210, can be enabled to create in memory for every object 270 in the GUI 240, a clone 250 or exact data replica of the corresponding one of the objects 270. For instance, each clone 250 can be created and stored with a corresponding nesting one of the objects 270 when the nesting one of the objects 270 is created for use in the GUI 240. The program code of the nested drag and drop module 300 further can be enabled to respond to a drag event by identifying a selected one of the objects 270 and others of the objects 270 that are nested in the selected one of the objects 270.

The program code of the nested drag and drop module yet further can be enabled to respond to the drag event first by generating an avatar 260 utilizing the selected one of the objects 270 and those of the clones 250 that correspond to the others of the objects 270 that are nested in the selected one of the objects 270, and second by utilizing the avatar 260 to visualize the dragging operation in the GUI 240. The program code of the nested drag and drop module even yet further can be enabled to respond to a drop event at a location in the GUI 240 by moving the selected one of the objects 270 and others of the objects 270 that are nested in the selected one of the objects 270 to the location in the GUI 240.

Of note, in one aspect of the embodiment, the program code of the nested object drag and drop module 300 can utilize the “Dojo” modular Javascript library. As such, an exemplary Dojo based implementation is illustrated herein:

var source1 = new dojo.dnd.Source(div1, { copyOnly:“true”,
creator: this.documentSetCreator });
source1.checkAcceptance = function( ){ return false; }
source1.insertNodes(false, [{data: {name: docSetName, docSetDocs:
docSetDocs }, type: [“documentSet”] },]);
var source2 = new dojo.dnd.Source(tr, {copyOnly:“true”, creator:
this.documentCreator, });
source2.checkAcceptance = function( ){return false; }
source2.insertNodes(false, [
{ data: docSetDocs[0], type: [“sendDocument”] },
{ data: docSetDocs[1], type: [“receiveDocument”] },
{ data: docSetDocs[2], type: [“sendDocument”] },
{ data: docSetDocs[3], type: [“receiveDocument”] },
]);
documentSetCreator: function( item, hint) {
var div = dojo.create( “div”, {innerHTML: item.data.name });
if (hint == “avatar”) {
var table = dojo.create(“table”, { }, div, “last”);
var tr = dojo.create(“tr”, { }, table, “last”);
for (var i=0; i<item.data.docSetDocs.length; i++) {
var td = dojo.create(“td”,{style: “text-align: center; padding:10px;”,
innerHTML: item.data.docSetDocs[i].number}, tr, “last”);
var img = dojo.create(“img”,{style: “display: block;margin-left:
auto;margin-right: auto”, src: “
http://localhost:8080/TPMaaS/images/document_obj.gif” }, td, “first”);
}
}
return {node: div, data: item, type: item.type, copyOnly: true};
},
documentCreator: function( item, hint ) {
var td = dojo.create(“td”,{style: “text-align: center; padding:10px;”});
var img = dojo.create(“img”,{style: “display: block;margin-left:
auto;margin-right: auto”, src: “
http://localhost:8080/TPMaaS/images/document_obj.gif” }, td);
var div = dojo.create(“div”,{innerHTML: item.data.number}, td);
return {node: td, data: item, type: item.type, copyOnly: true};
},

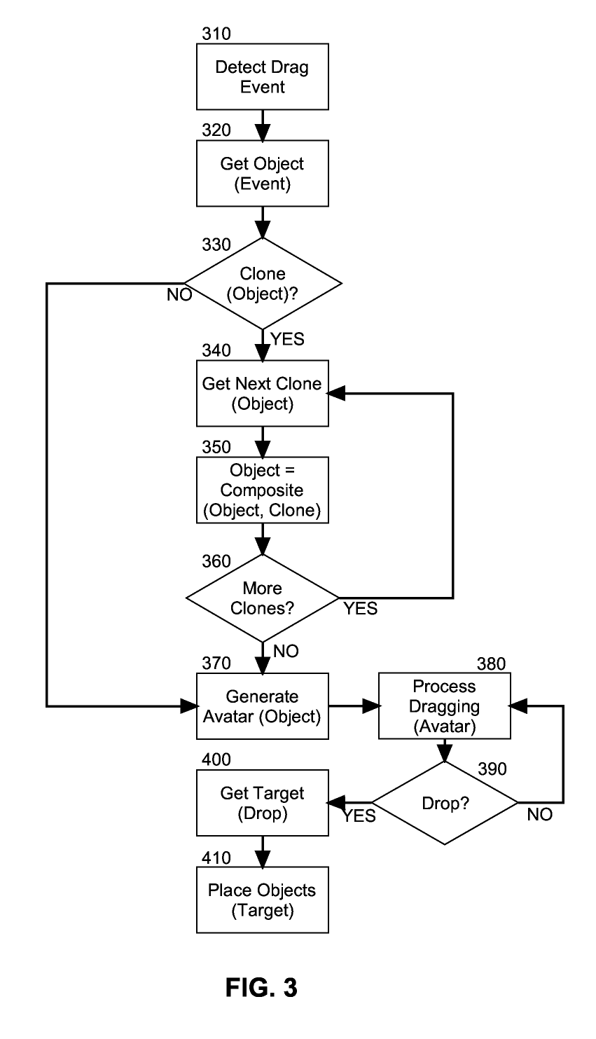

In even yet further illustration of the operation of the nested object drag and drop module 300, FIG. 3 is a flow chart illustrating a process for nested object drag and drop enablement utilizing object cloning. Beginning in block 310, a drag event can be detected in the GUI. In block 320, an object associated with the drag event can be identified and in decision block 330, it can further be determined whether or not one or more clones have been stored in connection with the identified object. If not, the process can proceed through block 370. Otherwise, the process can proceed through block 340.

In block 340, a first clone stored in connection with the identified object can be retrieved and a composition can be created as a combination of the identified object and the first clone in block 350. Thereafter, in decision block 360, if additional clones remain to be processed in connection with the identified object, in block 340 a next clone stored in connection with the identified object can be retrieved and the composition can be augmented as a combination of the composition and the next clone in block 350. In decision block 360, when no further clones remain to be processed in connection with the identified object, in block 370, an avatar can be generated based upon the composition.

In block 380, the avatar can be visually utilized to represent the dragging of the identified object and its nested objects from a source location in the GUI to a target location in the GUI. In decision block 390, if a drop event is detected, in block 400 a location corresponding to the drop event can be determined. Subsequently, in block 410, the identified object and those objects determined to be nested therein can be moved from the source location in the GUI to the target location in the GUI.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1.-3. (canceled)

4. A graphical user interface (GUI) data processing system comprising:
a host computer with memory and at least one processor;
an operating system executing in the memory of the host computer;
an application hosted by the operating system and providing a GUI with different objects displayed thereon; and,
a nested object drag and drop module coupled to the GUI, the module comprising program code enabled upon execution in the memory of the host computer to respond to a drag event in the GUI by identifying an object amongst the objects in the GUI associated with the drag event, by retrieving into the memory one or more clones of other objects in the GUI that are nested in the identified object, by generating an avatar for the identified object and the one or more clones, and by moving a display of the avatar from a source location of the drag event to a target location of a drop event detected in the GUI of the application.

5. The system of claim 4, wherein the clones are created and stored with the identified object when the identified object is created for use in the GUI.

6. The system of claim 4, wherein the program code is further enabled to respond to the drop event in the GUI of the application by determining the target location from the drop event and by moving to the target location in the GUI, the identified object and the other objects in the GUI that are nested in the identified object.

7. The system of claim 4, wherein the program is implemented utilizing to the Dojo modular Javascript.

8. A computer program product for nested object drag and drop enablement utilizing object cloning, the computer program product comprising:
a computer readable storage medium having computer readable program code embodied therewith, the computer readable program code comprising:
computer readable program code for detecting a drag event in a graphical user interface (GUI) of an application;
computer readable program code for identifying an object in the GUI associated with the drag event;
computer readable program code for retrieving in memory one or more clones of other objects in the GUI that are nested in the identified object;
computer readable program code for generating an avatar for the identified object and the one or more clones; and,
computer readable program code for moving a display of the avatar from a source location of the drag event to a target location of a drop event detected in the GUI of the application.

9. The computer program product of claim 8, wherein the clones are created and stored with the identified object when the identified object is created for use in the GUI.

10. The computer program product of claim 8, further comprising:
computer readable program code for detecting the drop event in the GUI of the application;
computer readable program code for determining the target location from the drop event; and,
computer readable program code for moving to the target location in the GUI, the identified object and the other objects in the GUI that are nested in the identified object.
